(19) United States
(12) Patent Application Publication
(10) Pub. No.: US 2004/0043817 A1
(43) Pub. Date: Mar. 4, 2004

(54) Autoconfiguration method for interactive on-line gaming systems

(76) Inventor: Daniel Willis, Stittsville (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/232,324

(22) Filed: Sep. 3, 2002

(51) Int. Cl. G06F 17/00

(52) U.S. Cl. 463/42

(57) ABSTRACT

An interactive gaming system comprising a gaming console and a gaming service provider is disclosed. The gaming console contains a storage medium, on which data relating to a configuration of the gaming console are stored. The gaming console further contains a processor in communication with the storage medium for retrieving data therefrom and executing the data, the data relating to the configuration of the gaming console. A gaming service provider provides instruction data to the gaming console, and a connecting network enables a connection between the gaming console and the gaming service provider. Further, a gaming client is stored on the gaming console. The gaming client establishes a connection between the gaming console and a gaming service provider and controls events taking place on the gaming console. The configuration of the gaming console is established by the gaming client according to messages sent to and received from the gaming service provider and to messages stored within a personal profile.

### FIELD OF THE INVENTION

The present invention generally relates to interactive gaming systems, and more specifically to on-line gaming systems wherein gaming clients are automatically configured and updated.

### BACKGROUND OF THE INVENTION

A common trend is emerging in modern designs of basic operating systems for computer systems, wherein the need to store more and more complex configuration information is steadily increasing. Moreover, to support new hardware configurations, as well as new software applications, storage of hardware settings into non-volatile memory is required, which in many cases needs to be done individually for each product out of a plurality of products. The storage of this configuration setting in the non-volatile memory requires greater use of non-volatile memory, and is highly product and version specific. As new products are developed and new versions introduced, more information to distinguish one product from another is added to the configuration register, to adequately describe differences among various products, as well as to adjust to personal preferences of an individual user of a given product. Some of these requirements have been described for example in U.S. Pat. No. 5,999,989 to Patel, issued Dec. 7, 1999.

In this context, new and exciting developments are currently taking place in computer gaming using gaming consoles (GC), and especially in interactive on-line computer gaming. During the last couple of years, on-line computer gaming has gained increasing popularity, and different Gaming Service Providers (GSP) have established themselves on the Internet network. On-line computer gaming is fast becoming a major money generating competitive virtual sport with tournament organizations and ranking services dedicated to providing the on-line community with the latest information and current rankings of global Internet gamers and game players. An interactive game server and on-line community forum is described for example in U.S. Pat. No. 6,339,761 to Sparks II, issued Mar. 5, 2002.

Computer gaming is constantly growing. Today thousands of players are playing on-line all around the world. Many people stereotype these people as techno kids only, but this could not be more wrong. Both females and males of all ages can be found daily trying to out-think, out-maneuver, or just having a good time on-line. On the Eve of the Electronic Entertainment Expo (E3Expo), the world's largest trade event showcasing computer and video games and related products, a new survey by Peter D. Hart Research Associates, Inc., has found that three-in-five Americans age six or older, or about 145 million people, say they routinely play computer or video games, and that nearly half of these game players are female. It is predictable that interactive on-line computer gaming will blur the line between games and other entertainment or communication media, and that the avenues explored in the development of on-line gaming might well break new ground for interactive Internet applications in all areas of business relations and social life.

Given the ongoing dynamic developments as well as future directions in the field of interactive on-line gaming, it would be highly advantageous to provide on-line gaming systems, wherein the configuration of a gaming console or any other gaming environment is automatically adjusted. This way, a system is able to easily react to flexible gaming scenarios, to be easily extendable to fulfill other functionalities besides gaming, to be easily adjustable according to certain user specific criteria. In view of the ever-changing world of on-line gaming covering all areas of human interest, some of which are of a restrictive nature for under-age audiences, it would also be highly desirable to achieve a good measure of parental control in interactive on-line computer gaming, yet not to exclude younger participants from possible future forms of social interaction.

### OBJECT OF THE INVENTION

It is therefore an object of the present invention to provide a system and method for interactive on-line gaming that is automatically adjustable to changes in gaming environments and user preferences.

### SUMMARY OF THE INVENTION

In accordance with an aspect of the instant invention, there is provided a gaming console for use as a gaming client and comprising at least a storage medium for having client data relating to a gaming client and for having data relating to a current game in execution stored therein, at least a processor in communication with the at least a storage medium for retrieving game instruction data therefrom and for executing the game instruction data to execute games on the gaming console and for retrieving client data therefrom for executing gaming client functions on the gaming console, and a transceiver for establishing a connection between the gaming console and a service provider, the connection for being controlled by the at least a processor in execution of the client data, wherein some of the client data is for execution of instructions for receiving further client data from the gaming service provider and for storing instruction data within the at least a storage medium and relating to the further client data, the stored instruction data for being executed by the processor to result in execution of gaming client functions, and, wherein the gaming console is absent an operating system supporting multiple simultaneous tasks for execution of multiple simultaneous games.

In accordance with another aspect of the instant invention, there is provided a method for providing an interactive gaming system service, the method comprising the steps of providing a gaming console comprising a storage medium for storing a gaming client for establishing a connection between the gaming console and a gaming service provider and for controlling events taking place on the gaming console coupling the gaming console to the gaming service provider through a broadband access network, and setting a configuration of the gaming console according to at least one of messages sent to and received from the gaming service provider and messages stored within the gaming console in a personal profile.

In accordance with yet another aspect of the instant invention, there is provided an interactive gaming system comprising a gaming console comprising at least a storage medium for having data relating to a configuration of the gaming console stored therein, the configuration including a current game in execution, and at least a processor in communication with the at least a storage medium for retrieving data therefrom and executing the data, the data relating to the configuration of the gaming console, a gaming service provider for providing instruction data to the gaming console, a connecting network for enabling a connection between the gaming console and the gaming service provider, wherein a gaming client is stored in the at least a storage medium of the gaming console, the gaming client for establishing a connection between the gaming console and a gaming service provider and for controlling events taking place on the gaming console; and wherein the configuration of the gaming console is established by the gaming client according to at least one of messages sent to and received from the gaming service provider and messages stored within a personal profile.

### BRIEF DESCRIPTION OF THE DRAWINGS

An exemplary embodiment of the present invention will be described in conjunction with the following drawings, in which similar reference numbers designate similar items:

FIG. 1 displays a schematic diagram of an on-line gaming architecture;

FIG. 2 displays a schematic diagram of an on-line gaming software architecture;

FIG. 3a displays a message sequence chart of an auto-versioning process for an ultra-thin client;

FIG. 3b displays a message sequence chart of a support process for an ultra-thin client; and

FIG. 3c displays a message sequence chart of a selection process for an ultra-thin client.

### DETAILED DESCRIPTION OF THE INVENTION

The present invention is now described with respect to a specific embodiment thereof, wherein a gaming link architecture G_linkA is used to provide an on-line gaming service, and wherein a certain gaming link protocol G_linkP is used to establish data communication within G_linkA. Of course, the invention described herein is not restricted to a particular example, which will be described in what follows, but equally applies to other architectures possibly used to establish and provide an on-line gaming scenario.

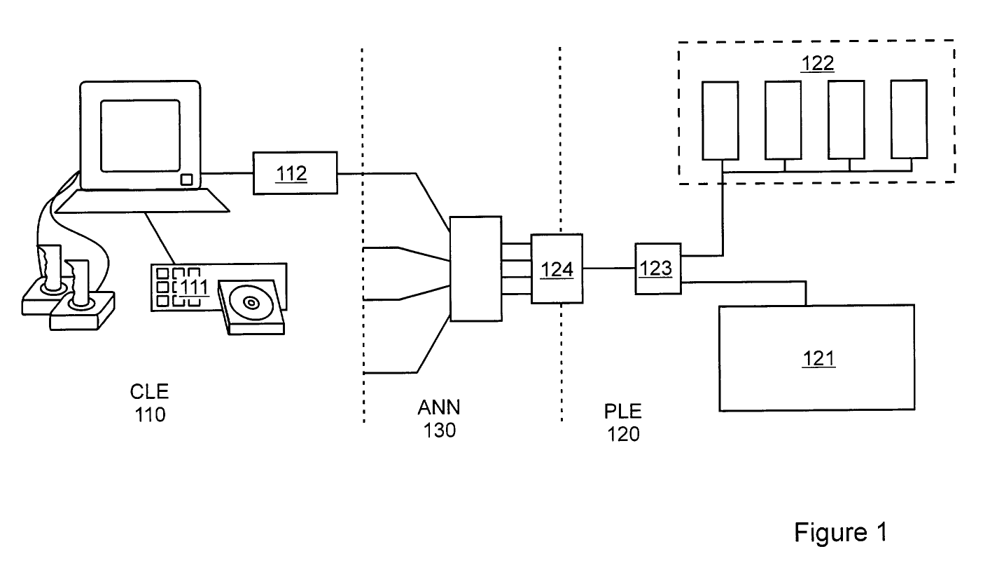

Referring to FIG. 1, a schematic diagram of the gaming link architecture G_linkA for providing an on-line gaming environment is presented. The main components of G_linkA are a customer site containing customer located equipment CLE 110, a provider site containing provider located equipment PLE 120, and an access aggregation network AAN 130 connecting CLE 110 with PLE 120. The customer located equipment CLE 110 includes a gaming console GC 111 and other hardware components necessary for playing a game, such as a monitor, joysticks, and the like, and a modem such as a broad band modem 112 for establishing the connection to the AAN 130. On the PLE site 120 there is located a gaming service provider network GSP 121, a management network 122 consisting of multi-service operator's operations support systems MSO-OSS 123, a router 123 and a head-end 124, establishing the connection to the ANN 130, among other components. The access aggregation network ANN 130 generally is a wide area network WNA, and preferably a broadband access network BAN. However, local area networks LAN are also possible solutions for networks providing an on-line gaming service.

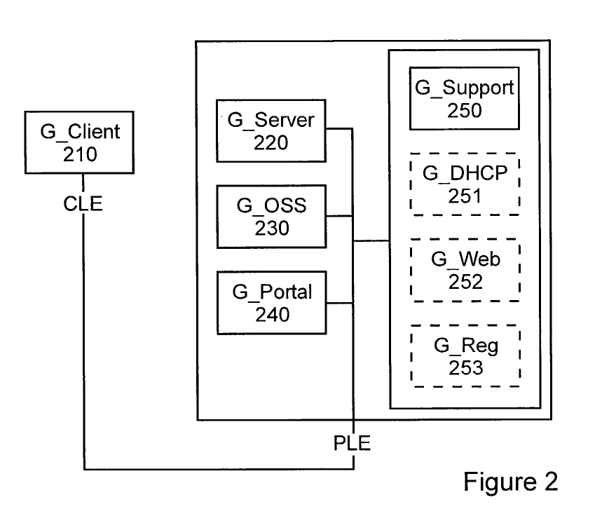

Referring now to FIG. 2, a schematic diagram is shown, illustrating the basic elements of the software architecture used in providing an on-line gaming environment. On the CPE site, the main component is a gaming client G_Client 210, whereas on the PLE site there is a gaming server G_Server 220, an operations support services engine G_OSS 230, a gaming portal G_Portal 240, and support services G_support 250.

The purpose of the gaming client G_Client 210 is to provide the gaming console with services, such as establishing connectivity, registration, and instrumentation. G_Client 210 comprises a registration client, an authentication client, a console address management module, and a module for connectivity and service to a gaming service provider GSP 121 on the PLE site 120. G_Client 210 supports established methods for data communication and transfer, such as Point-to-Point Protocol PPP, and other recognized data protocols. G_Client 210 checks for connection qualification, and administers bundled instrumentation. According to the embodiment of the present invention, and especially useful in connection with a broadband access network (BAN), a highly functional and adaptive client in form of an ultra-thin client UTC is chosen as the component G_Client 210. UTC resides on the console in a small segment of random access memory (RAM), thus leveraging a high bandwidth connection to the gaming console, and using it to care and feed the highly functional and adaptive client. In this case, the component G_Client 210 is typically referred to as G_UTC.

The UTC constitutes a continuously resident, tiny core framework, in which client functionality is partitioned into small code segments, loaded and launched as required at run time. The code segments or packages are small, in general 50 KB or less, and with a broadband bandwidth of about 2 Mbps take milliseconds to load. With UTC, there is no need to maintain state tables; UTC itself becomes a state onto itself, including possible launches from that state. UTC packages are thin, take little space away from the primary function of the GC, and do hardly interfere with the gaming software running on the GC. As a further advantage, the gaming client G_Client 210 becomes very scalable and flexible, and is growing outside the GC without impacting the footprint occupied within the GC. As another advantage, client upgrades and updates are done automatically and in-service, value-added services are simple to include, and individual client services are easier to design and to implement. Also, client code portability between different gaming platforms is highly simplified. This way, G_UTC is a prototypical example for a highly functional client.

The purpose of the gaming server G_Server 220 is to provide the connectivity and registration services for gaming consoles (GC), and to manage the registered devices. Typically, G Server 220 deals with client registration, subscriber authentication, console address management, as well as Internet protocol (IP) connectivity management and proxy for gaming consoles (GC). G_Server 220 also manages the different GC and different subscribers being part of the on-line gaming architecture G_linkA. Further, G_Server 220 deals with connection qualification, instrumentation and debugging services for consoles, and with bundled instrumentation, and reports facilities for instrumentation, performance and management to G_Client 210. Although designed as an on-line gaming environment, G_Server 220 enables one to extend the uses of a plurality of gaming consoles (GC) interconnected through a broadband access network beyond gaming and entertainment.

The purpose of the operations support services engine G_OSS 230 is to provide an application program interface (API) to tie-in with the network service provider's software engines for subscriber authentication, network and policy management, notification, and billing functionalities. G_OSS 230 supports multi-protocol API, containing common utilities with plug-in adapters to facilitate connectivity to a majority of other operating support services (OSS), the plug-in adaptation cartridges supporting Hyper Text Transfer Protocol (http), Simple Network Management Protocol (SNMP), eXtensible Markup Language (XML), JAVA™, OSS/J, and the like. Further, G_OSS 230 handles the task of console-discovery-notification and registration, communicates console to subscriber associations, manages subscriber authentication, and administers connectivity management while addressing state functions such as in-service, suspend, or resume. Also, G_OSS 230 adds, modifies, or deletes a GC or a subscriber to the on-line gaming service, and takes care of billing and service notification, among other related functionalities.

The purpose of the gaming portal G_Portal 240 is to provide a site for net-based gaming services. It also acts as a proxy site through which net-based game content providers offer content and services to the user of the gaming console GC. G_Portal 240 provides an entry point into the on-line gaming network for game specific servers, for connection servers enabling group gaming, head-to-head services and find-a-friend scheduling, for bulletin boards and chat rooms, as well as for gaming sites and news proxy.

Optionally, G_Portal 240 offers possibilities such as pay-per-play services, advertising, download services, and others. G_Server 220 also locally offers the same services.

The system of support services G_support 250 fulfills functions such as running a dynamic host configuration protocol (DHCP), Web servicing, platform and application management, subscriber management, license servicing, and the like. Within the system of support services, there is a dynamic host configuration protocol server G_DHCP 251, a Web server G_Web 252 dealing with GSP content, GSP data, and GSP instrumentation, as well as a registration server G_Reg 253.

G_linkP is used to establish communication within the gaming architecture G_linkA, and is used in supporting the intermodule signaling and control communication and small batch data transfer. G_linkP further enables the use of ultra-thin clients (UTC) for gaming consoles (GC). In the present embodiment of the instant invention, the communication medium is an IP-based, packet protocol, running on IP directly, or on top of a Point-to-Point Protocol (PPP) including PPP use over Ethernet (PPPoE), utilizing XML for external interfaces, and supporting both connected clients via the Transmission Control Protocol (TCP) as well as connectionless clients via the User Datagram Protocol (UDP). Further, G_linkP attempts to keep small messages, typically smaller than the maximum transmission unit (MTU).

All protocol messages have a common base structure, comprising header, payload, and tail. The header includes information regarding protocol version, message type, control flags, sequence counter, security field, identification of the originating module, identification of the destination module, gaming console class, gaming console vendor, gaming console model, payload size, payload type, and other relevant data characterizing the type and format of the message. The payload contains the main body of the message, comprising any or all of unstructured binary data, structured, formatted data, XML-text-based data, and other interpretable data. Optionally, depending on the message type, the tail comprises a sequence counter, a security field, and/or control flags.

Typical message types of the gaming link protocol include a logon-message GlP_Hello, a response message GlP_Rsp, a request for download GlP_DReq, an acknowledgment message GlP_ACK, as well as a non-acknowledgement message GlP_NAK, an information package GlP_Info, a data package GlP_Data, and a control package GlP_Control. The main communication between the CLE site 110 and the PLE site 120 over the AAN 130 is handled by the client G_Client 210 and the server services G_Server 220.

A boot process of the gaming console GC generally starts an on-line gaming session. First loading the UTC base G_UTC from a compact disc (CD) or from read-only memory (ROM) into random access memory (RAM) initializes a sequence of start-up steps. In this first step, client identification (ID), information regarding the make and the model of the GC, as well as the Internet Protocol (IP) address all are retrieved from RAM.

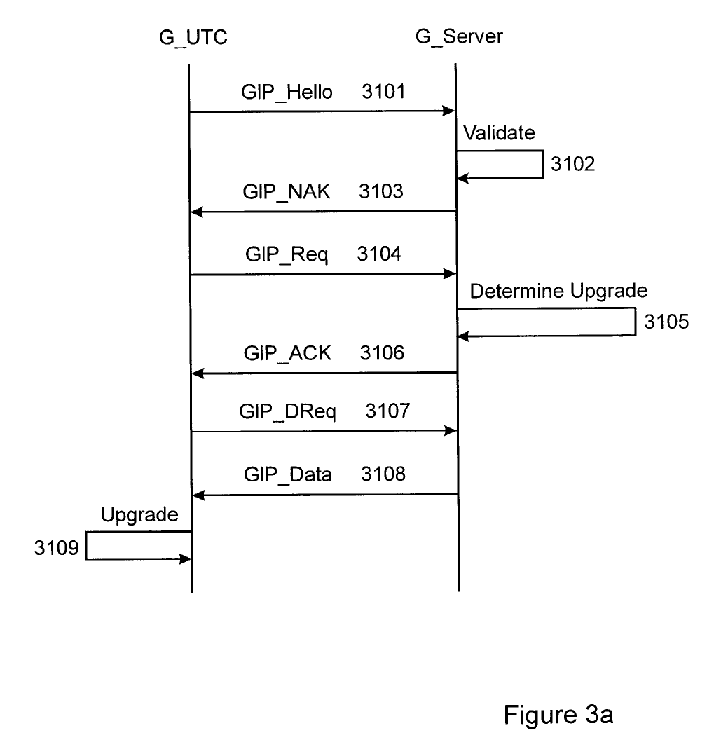

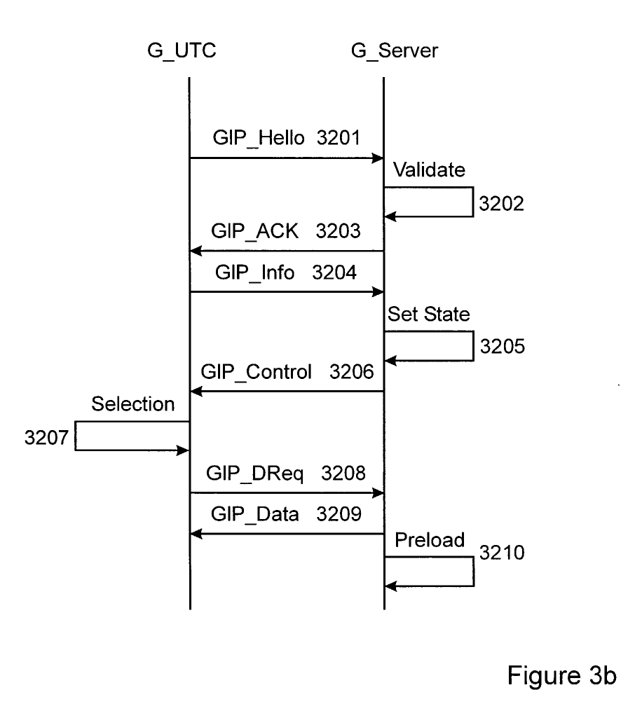

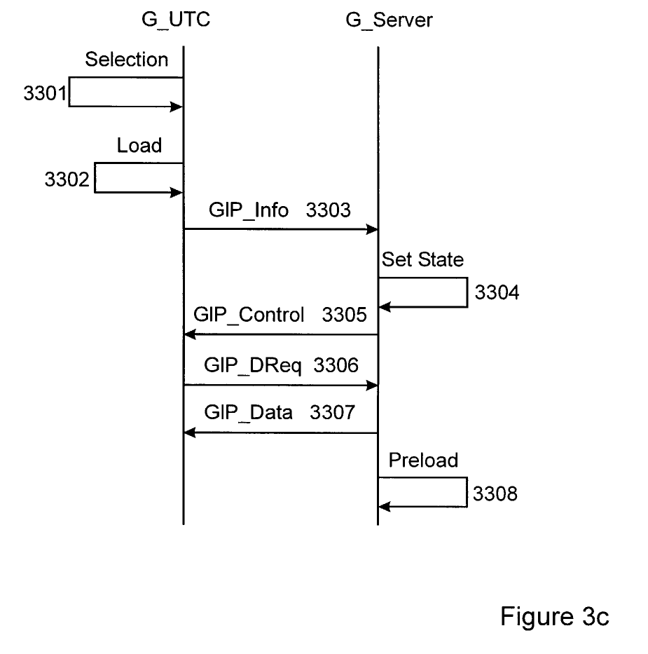

Referring now to FIG. 3a, a message sequence chart (MSC) is shown for an auto-versioning process of the gaming console GC. It is assumed that the client has a valid and authenticated IP address and client ID. The client G_UTC transmits a logon message GlP_Hello to the GSP server G_Server, step 3101. The logon message contains information regarding the client ID, the version number of G_linkP used, and the like. Next, G_Server is going to validate the client and the protocol used, step 3102. G_Server looks up the client ID for validity, and decides whether the version of G_linkP is currently supported. In case of an outdated protocol version, a non-acknowledgment message is sent to the client, step 3103, containing an address and port of updated client software. In a next step, the client requests a proper update, step 3104, which is followed by the server determining the data for a correct update, step 3105. The new updated version is determined taking into account new protocol versions, client console class and type, console make and model, and related information. The information is sent to the client G_UTC in form of an acknowledgment message, step 3106. The client then requests a download for the updated version, step 3107, transmitting the necessary information such as updated file name and client ID, to the server G_Server. The server G_Server transmits data containing the new UTC version of the client, step 3108. The auto-versioning procedure is concluded with an upgrade, step 3109. The new base client UTC is loaded, and an update flag for NVRAM is set. If the new client is successfully activated, and if the update flag is set, the new client is loaded into RAM. Optionally, after being loaded into RAM, the new client is preserved in NVRAM, if it was originally stored in NVRAM. Otherwise, if the update flag is not set, the old base client is reactivated, and the autoconfiguration procedure is repeated.

Referring now to FIG. 3b, a message sequence chart (MSC) is shown, how a UTC client is supported by the support services, and especially by G_Server. It is assumed that the client has a valid and authenticated IP address and client ID. It is further assumed that G_UTC is running. The client G_UTC transmits a logon message GlP_hello to the GSP server G_Server, step 3201. The logon message contains information regarding the client ID, the version number of G_linkP used, and the like. Next, G_Web is going to validate the client and the protocol used, step 3202. G_Web looks up the client ID for validity, and decides whether the version of G_linkP is currently supported. In case of authenticated information, an acknowledgment message is sent to the client, step 3103. The client G_UTC then transmits information to the server G_Web, regarding an active element of the client, step 3204. The active element refers for example to a particular gaming situation of an ongoing interactive computer game, or it possibly refers to information determining gaming characteristics of a certain user, such as information contained in a personal profile. The support server sets a state and a jump table, and updates a client record, step 3205. This step is based on a current state and transition table of the client, and transition options with prompts and probabilities are determined. These options are sent back to the client as control data, step 3206. G_UTC then presents a menu to the user, step 3207. Possible options are different choices within a gaming scenario, different gaming services to be loaded and activated, different gaming qualities, and the like. After the selection is made, the client transmits the corresponding download request, step 3208, and the server responds by transmitting the corresponding data to the client, step 3209. Optionally, based on certain probabilities with respect to certain download requests, G_Server chooses to preload one or more selection modules, step 3210, the modules resulting from a next probable transition taking place on the CLE site. This prefetching process represents a form of caching, which provides the end user with real-time responsiveness.

Referring now to FIG. 3c, a message sequence chart (MSC) is shown, for a method of UTC selection. The client G_UTC is running on the GC, and is offering a menu of selections to the subscriber, or to a user on the CLE site, step 3301. Optionally, one or more than one probable selections are preloaded by G_UTC. The subscriber or user then makes a selection, which corresponds to a transition for G_UTC. G_UTC loads and runs the selected transition, step 3302. Optionally, when the selection was preloaded, a process of loading the selection is not required. A new state is now loaded and activated. G_UTC stays active as supervisor, and for a return to a main menu, but spawns a selected transition module. The client G_UTC then transmits information to the server G_Server, regarding an active element of the client, step 3303. The active element refers for example to a particular gaming situation of an ongoing interactive computer game, or it possibly refers to information determining gaming characteristics of a certain user, such as information contained in a personal profile. The support server sets a state and a jump table, and updates a client record, step 3304. This step is based on a current state and transition table of the client, and transition options with prompts and probabilities are determined. These options are sent back to the client as control data, step 3305. The client transmits a corresponding download request, step 3306, and the server responds by transmitting the corresponding data to the client, step 3307. Optionally, based on certain probabilities with respect to certain download requests, G_Server chooses to preload one or more selection modules, step 3308, the modules resulting from a next probable transition taking place on the CLE site.

The above-described procedures illustrate the basic modus operandi of the instant invention, and it is obvious to a person of skill in the art that the presented communication protocols are easily extended to incorporate and fulfill a variety of other functionalities. Besides the described autoconfiguration procedure, the UTC selection step possibly offers a selection of configuration options that are settable and adaptable by the subscriber or by the user. For example, certain gaming requests are excluded from the GC, or are only possible to be activated at a certain point in time, say in the evening after 10 p.m. Selected options are then stored in a personal profile. The selected options include options regarding gaming executed on the gaming console, options regarding parental control issues, and other options. The personal profile is either located on the provider site, associated with a client ID and IP address, and is accessed by the support services when a request from a certain client is registered, or the profile is stored in the NVRAM of the gaming console, and is loaded at boot time. Alternatively, a given personal profile is not associated with a specific IP address, but is associated with a net-mask or a subnet-mask. This way, for example, a complete home is declared as a violence free gaming zone.

The personal profile is optionally used to protect the GSP from certain legal liabilities. For example, according to a given legislation, the provider of a game, and therefore by extension the GSP, has a liability and/or a responsibility to ensure age appropriate contents. By using the personal profile to determine an age profile of its audience, an appropriate UTC instance is loaded enforcing and allowing only approved age appropriate content. This way, the GSP exercises age control on the services and games provided.

The same way as the personal profile is used to exercise age control, the personal profile is optionally used to exercise parental control. It is possible for parents to block the access to certain type of games, which for example engage their user in violent actions, confront their users with sexual content, and challenge their user with contents of profanity. This way, it is possible for parents to ensure that their educational measures are not undermined by gaming activities performed by their children in their recreational activities. This way, it is possible for younger audience to safely participate in new forms of social interactions related to online gaming activities. Of course, the concept of parental control as described above is easily extended to other forms of control for designated user groups of a given gaming console (GC).

The autoconfiguration procedure also allows one to efficiently deal with security issues. G_UTC itself is the distributed key for security, and the possibility to constantly and automatically update G_UTC introduces enough flexibility into the gaming system, to provide a secure gaming environment.

Although the instant invention has been described with respect to a specific embodiment thereof, various changes and modifications are optionally carried out by those skilled in the art without departing from the scope of the invention. Therefore, it is intended that the instant invention encompass such changes and modifications as fall within the scope of the appended claims.

What is claimed is:

1. A gaming console for use as a gaming client and comprising:
at least a storage medium for having client data relating to a gaming client and for having data relating to a current game in execution stored therein;
at least a processor in communication with the at least a storage medium for retrieving game instruction data therefrom and for executing the game instruction data to execute games on the gaming console and for retrieving client data therefrom for executing gaming client functions on the gaming console;
a transceiver for establishing a connection between the gaming console and a service provider, the connection for being controlled by the at least a processor in execution of the client data,
wherein some of the client data is for execution of instructions for receiving further client data from the gaming service provider and for storing instruction data within the at least a storage medium and relating to the further client data, the stored instruction data for being executed by the processor to result in execution of gaming client functions, and,
wherein the gaming console is absent an operating system supporting execution of multiple simultaneous games.

2. A gaming console as defined in claim 1, wherein the at least a storage medium includes non-volatile random access memory.

3. A method for providing an interactive gaming system service, the method comprising the steps of:
providing a gaming console comprising a storage medium for storing a gaming client for establishing a connection between the gaming console and a gaming service provider and for controlling events taking place on the gaming console, the gaming console being absent an operating system supporting execution of multiple simultaneous games;
coupling the gaming console to the gaming service provider through a broadband access network; and
establishing a configuration of the gaming console according to messages received from the gaming service provider, the configuration including events taking place on the gaming console.

4. A method for providing an interactive gaming system service as defined in claim 3, wherein the storage medium is non-volatile random access memory.

5. A method for providing an interactive gaming system service as defined in claim 3, wherein the storage medium is random access memory.

6. A method for providing an interactive gaming system service as defined in claim 3, wherein the storage medium is read-only memory.

7. A method for providing an interactive gaming system service as defined in claim 3, wherein the storage medium is a compact disc.

8. A method for providing an interactive gaming system service as defined in claim 4, wherein the personal profile is stored in the non-volatile random access memory.

9. A method for providing an interactive gaming system service as defined in claim 3, wherein the personal profile is stored within the interactive gaming system and including a step of validating the personal profile by the gaming service provider.

10. A method for providing an interactive gaming system service as defined in claim 9, wherein the personal profile is stored within the gaming service provider.

11. A method for providing an interactive gaming system service as defined in claim 9, wherein the personal profile is stored within the gaming console.

12. A method for providing an interactive gaming system service as defined in claim 9, wherein the personal profile is associated with an identification data of the gaming console.

13. A method for providing an interactive gaming system service as defined in claim 12, wherein the identification data relates to access to the broadband access network.

14. A method for providing an interactive gaming system service as defined in claim 13, wherein the identification data relates to an IP address of the gaming console.

15. A method for providing an interactive gaming system service as defined in claim 13, wherein the identification data relates to a net-mask of the gaming console.

16. A method for providing an interactive gaming system service as defined in claim 9, wherein the personal profile is associated with data relating to parental control.

17. An interactive gaming system comprising:
a gaming console comprising at least a storage medium for having data stored therein, the data relating to establishing a configuration of the gaming console, the configuration comprising events taking place on the gaming console, and at least a processor in communication with the at least a storage medium for retrieving data therefrom and executing the data, the data when executed establishing the configuration of the gaming console, the gaming console being absent an operating system supporting execution of multiple simultaneous games;
a gaming service provider for providing instruction data to the gaming console;
a connecting network for enabling a connection between the gaming console and the gaming service provider;
wherein a gaming client is stored in the at least a storage medium of the gaming console, the gaming client for establishing a connection between the gaming console and a gaming service provider and for controlling data stored in the storage medium; and
wherein the data are stored in the storage medium according to instruction data received from the gaming service provider.

18. A method for providing an interactive gaming system service as defined in claim 17, wherein the at least a storage medium is non-volatile random access memory.

19. A method for providing an interactive gaming system service as defined in claim 17, wherein the at least a storage medium is random access memory.

20. A method for providing an interactive gaming system service as defined in claim 17, wherein the at least a storage medium is read-only memory.

21. A method for providing an interactive gaming system service as defined in claim 17, wherein the at least a storage medium is a compact disc.

22. A method for providing an interactive gaming system service as defined in claim 18, wherein the personal profile is stored in the non-volatile random access memory of the gaming console.

23. A method for providing an interactive gaming system service as defined in claim 17, wherein the personal profile is stored within the interactive gaming system.

24. A method for providing an interactive gaming system service as defined in claim 23, wherein the personal profile is stored within the gaming service provider.

25. A method for providing an interactive gaming system service as defined in claim 23, wherein the personal profile is stored within the gaming console.

26. A method for providing an interactive gaming system service as defined in claim 23, wherein the personal profile is associated with an identification data of the gaming console.

27. A method for providing an interactive gaming system service as defined in claim 26, wherein the identification data relates to access to the broadband access network.

28. A method for providing an interactive gaming system service as defined in claim 27, wherein the identification data relates to an IP address of the gaming console.

29. A method for providing an interactive gaming system service as defined in claim 27, wherein the identification data relates to a net-mask of the gaming console.

30. A method for providing an interactive gaming system service as defined in claim 23, wherein the personal profile is associated with data relating to parental control.
